(19) United States
(12) Patent Application Publication
(10) Pub. No.: US 2006/0056294 A1
(43) Pub. Date: Mar. 16, 2006

(54) Methods and apparatuses for switching system modules in computer systems

(75) Inventors: Ying-Chun Tseng, Taipei City (TW); Tou-Wen Hsieh, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: ASROCK Incorporation

(21) Appl. No.: 11/176,761

(22) Filed: Jul. 7, 2005

(30) Foreign Application Priority Data
Aug. 27, 2004 (TW) 93125993

(51) Int. Cl. H04L 12/26

(52) U.S. Cl. 370/229

(57) ABSTRACT

Methods for switching system modules in a computer system. The computer system includes a first system module, a second system module, and system programs. The system programs include a first and a second system program, corresponding to the first and second system modules respectively. A switching component, such as a transistor, is first provided. An address control signal from the switching component is then received. The first system program is executed if the address control signal is a first signal. Otherwise, the second system program is executed if the address control signal is a second signal.

### BACKGROUND

The invention relates to system control for a computer system, and in particular to computer system switching system modules.

Conventionally, a computer system contains only one system module. A system module, such as a motherboard module, is a module for system control in a computer system and generally contains a central processing unit (CPU). Thus, system programs thereof, such as BIOS (Basic Input Output System), coordinate only for one system module.

Currently, computer systems may have different system modules. For example, a computer may comprise two motherboard modules. Generally, different system modules correspond to different system programs stored in different storage units, such as flash ROM (flash read-only memory).

If a computer system stores system programs, corresponding to different system modules, in one storage unit, the conventional and present system control method is inadequately. Thus, methods for storage of different system programs, corresponding to different system modules, in a single storage unit capable of proper execution in computer systems with multiple system modules is desirable.

For example, a computer system comprises two different motherboard modules with different central processing units. The disposed motherboards may represent distinct operational levels. The system programs, for example the BIOS, may alternate. Thus, methods for storage of system programs, corresponding to individual CPUs, in a signal flash ROM is critical.

### SUMMARY

In an exemplary embodiment of a method for switching system module in a computer system, a switching component is first provided. The provided switching component produces an address control signal. System programs are executed according to the produced address control signals.

The computer system contains first and second system modules. The computer system also comprises system programs. A first central processing unit is disposed in the first system module and a second central processing unit is disposed in the second system module. The system programs include a first system program, corresponding to the first system module, and a second system program, corresponding to the second system module. The system programs, such as basic input/output system (BIOS), can be stored in firmware.

A switching component, such as a transistor, a specific IC, or a switch, is first provided to produce an address control signal. The address control signal from the switching component is then received. If the switching component is coupled to the first system module, the address control signal is a first signal, such as a high electric potential signal. Thus, the first system program is executed. If the switching component is coupled to the second system module, the produced address control signal is a second signal, such as a low electric potential signal. Thus, the second system program is executed.

### DESCRIPTION OF THE DRAWINGS

The invention can be more fully understood by reading the subsequent detailed description and examples with references made to the accompanying drawings, wherein:

FIG. 1 is a flowchart of an embodiment of a method for switching system modules in a computer system in accordance with the present invention.

FIG. 2 is a diagram of an embodiment of an apparatus for switching system modules in a computer system in accordance with the present invention.

FIG. 3 is a diagram of an exemplary computer system comprising an embodiment of a switching module apparatus in accordance with the present invention.

FIG. 4 is a diagram of an embodiment of system programs for switching modules in a computer system in accordance with the present invention.

### DESCRIPTION

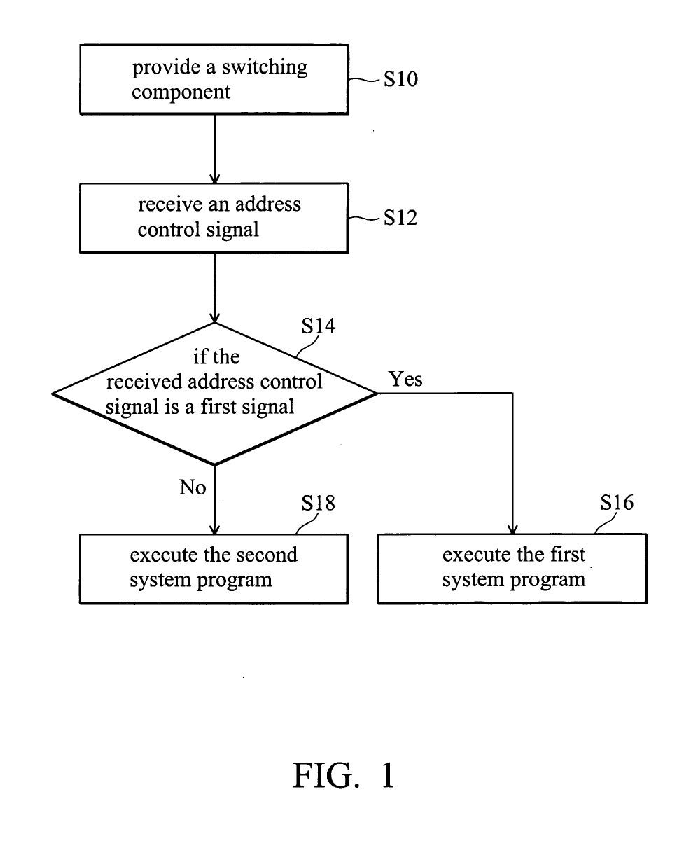

Methods and apparatuses for switching system module in a computer system are provided. FIG. 1 is a flowchart of an embodiment of a method for switching system modules in a computer system. In some embodiments, a method of switching system module is employed in a computer system containing a first and a second system modules. The first system module comprises a first central processing unit while the second system module comprises a second central processing unit. The computer system also includes system programs. The system programs comprise a first system program, corresponding to the first system module, and a second system program, corresponding to the second system module. The system programs can be stored in firmware.

A switching component is first provided (step S10). Next, an address control signal is received from the switching component (step S12). It is then determined if the received address control signal is a first signal (step S14). The first signal is produced when the switching component connects to the first system module. The first signal can, for example, be a high electric potential signal. If the address control signal is the first signal, the first system program is executed (step S16). In step S14, the address control signal may be a second signal, produced when the switching component connects to the second system module. If the address control signal is the second signal, for example, a low electric potential signal, the second system program is executed (step S18). Proceeding to step S18, the switching component can be reset to the first signal for avoiding error occurrence in further operations, such as program update or upgrade.

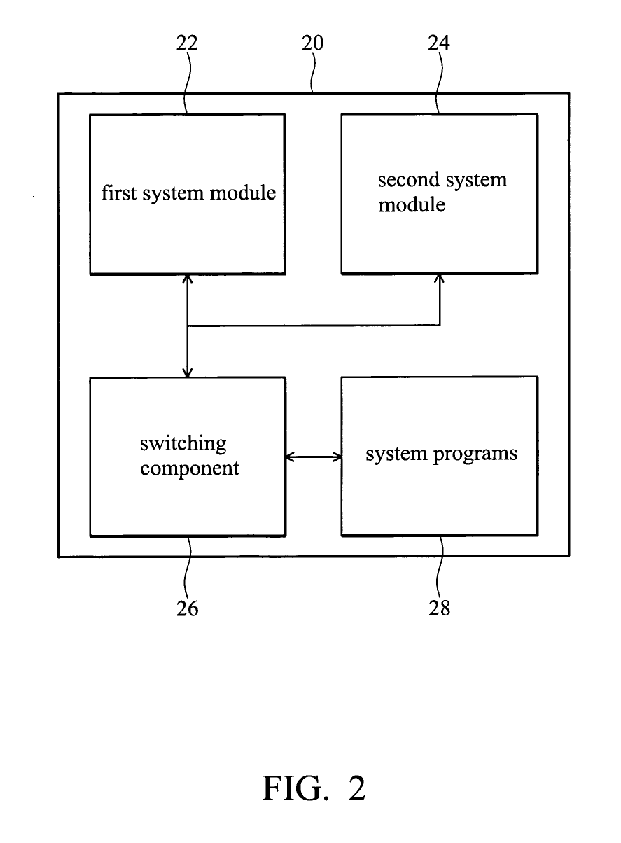

FIG. 2 is a diagram of an embodiment of an apparatus for switching system modules in a computer system. In some embodiments, an apparatus for switching system modules in a computer system is provided. The computer system 20 comprises a first system module 22 and a second system module 24. The first system module 22 comprises a first central processing unit (CPU) and the second system module 24 comprises a second CPU.

In some preferred embodiments, a computer system 20 may comprise an original motherboard module 22 with an AMD K7 series CPU. The computer system 20 may additionally comprise another motherboard module 24 with an AMD K8 series CPU. But the type of CPUs are not limited to the AMD CPU mentioned thereof. Additionally, different CPUs may be established integrated on one motherboard or on individual motherboards. The computer system, however, can be any computer system including two or more system modules, comprising different central processing units.

The computer system 20 comprises a switching component 26 and system programs 28. The switching component 26 may be a transistor or a specific IC. The system programs 28 include a first system program, corresponding to the first motherboard module 22, and a second system program, corresponding to the second motherboard module 24. The system programs 28 receive an address control signal from the switching component 26. If the address control signal is a first signal, the first system program is executed. If the address control signal is a second signal, the second system program is executed. The first signal may be a high electric potential signal while the second signal may be a low electric potential signal. The second signal is produced when the switching component 26 connects to the second motherboard module 24. The system programs 28 can be implemented as firmware.

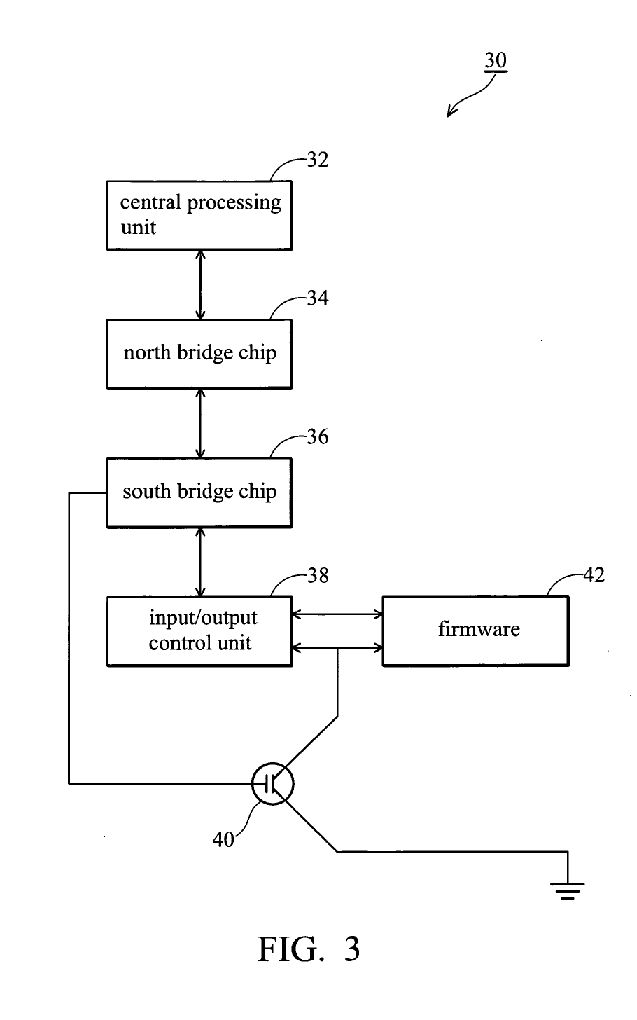

FIG. 3 is a diagram of an exemplary computer system comprising an embodiment of a switching module apparatus. A computer system 30 comprises a central processing unit 32, a north bridge chip 34, a south bridge chip 36, input/output control unit 38, a switching component 40, and firmware 42.

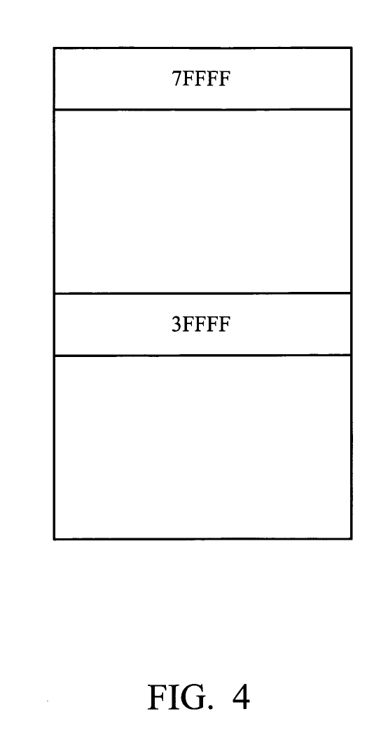

Firmware 42 stores a first and a second system programs, corresponding to a first and a second system module respectively. Referring to FIG. 4, FIG. 4 is a diagram of an embodiment of system programs for switching modules in a computer system. The first system program is stored at a location with a beginning address of 7FFF. The second system program is stored at a location with a beginning address of 3FFFF.

If the switching component 40 connects to the first system module, the first system module, comprising a first level central processing unit is active. The switching component 40 produces a high electric potential signal, such that the whole address produced by the input/output control unit 38 and the switching component 40 is 7FFF. The first system program is then executed accordingly.

If the second system module, containing a second level central processing unit, is active, the switching component 40 produces an address control signal as a low electric potential signal. Thus, the address produced by the input/output module 38 and the switching component 40 is 3FFF. The second system program is then executed based on the address.

Methods and apparatuses for switching system modules in a computer system may potentially resolve system module switching problems. In some embodiments, methods and apparatus for switching system modules in a computer system store different system programs in one signal storage unit instead of two distinct units. Different system programs can be executed through the address control signal produced by a switching component to accomplish system module switching.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for switching system modules in a computer system comprising a first system module, a second system module, and system programs, wherein the system programs contain a first system program corresponding to the first system module and a second system program corresponding to the second system module, the method comprising:
providing a switching component;
receiving an address control signal from the switching component;
executing the first system program if the address control signal is a first signal; and
executing the second system program if the address control signal is the second signal.

2. The method for switching system modules in a computer system as claimed in claim 1, wherein the second signal is produced when the switching component couples to the second system module.

3. The method for switching system modules in a computer system as claimed in claim 1, wherein the switching component is a transistor.

4. The method for switching system modules in a computer system as claimed in claim 1, wherein the first signal is a high electric potential signal.

5. The method for switching system modules in a computer system as claimed in claim 1, wherein the second signal is a low electric potential signal.

6. The method for switching system modules in a computer system as claimed in claim 1, wherein the system programs are stored in firmware.

7. The method for switching system modules in a computer system as claimed in claim 1, wherein the first system module comprises a first central processing unit.

8. The method for switching system modules in a computer system as claimed in claim 1, wherein the second system module comprises a second central processing unit.

9. An apparatus for switching system modules in a computer system comprising a first system module and a second system module, comprising:
a switching component; and
system programs receiving an address control signal from the switching component, executing a first system program if the address control signal is a first signal, and executing a second system program if the address control signal is a second signal, wherein the system programs comprise the first system program, corresponding to the first system module, and the second system program, corresponding to the second system module.

10. The apparatus for switching system modules in a computer system as claimed in claim 9, wherein the second signal is produced when the switching component couples to the second system module.

11. The apparatus for switching system modules in a computer system as claimed in claim 9, wherein the switching component is a transistor.

12. The apparatus for switching system modules in a computer system as claimed in claim 9, wherein the first signal is a high electric potential signal.

13. The apparatus for switching system modules in a computer system as claimed in claim 9, wherein the second signal is a low electric potential signal.

14. The apparatus for switching system modules in a computer system as claimed in claim 9, wherein the system programs are stored in firmware.

15. The apparatus for switching system modules in a computer system as claimed in claim 9, wherein the first system module comprises a first central processing unit.

16. The apparatus for switching system modules in a computer system as claimed in claim 9, wherein the second system module comprises a second central processing unit.
